(19) United States
(12) Patent Application Publication
(10) Pub. No.: US 2026/0342007 A1
(43) Pub. Date: Oct. 29, 2026

(54) LEVER-TYPE CONNECTOR

(71) Applicants: SUMITOMO WIRING SYSTEMS, LTD., Mie (JP); NISSAN MOTOR CO., LTD., Kanagawa (JP)

(72) Inventors: Toshihiro ITO, Mie (JP); Takahiro KIKUCHI, Mie (JP); Tsuyoshi MASE, Mie (JP); Aritsugu HIROSE, Kanagawa (JP)

(73) Assignees: SUMITOMO WIRING SYSTEMS, LTD., Mie (JP); NISSAN MOTOR CO., LTD., Kanagawa (JP)

(21) Appl. No.: 19/657,308

(22) Filed: Apr. 24, 2026

(30) Foreign Application Priority Data
Apr. 25, 2025 (JP) 2025-073016

(51) Int. Cl. H01R 13/629

(52) U.S. Cl. CPC H01R 13/62933

(57) ABSTRACT

A lever includes a lever side portion engageable with a mating connector. A side surface of a housing covered by the lever side portion is provided with a stop portion and a stopper portion protruding from the side surface. A retainer includes a retainer side portion that is locked to the stop portion at a main locking position. An inner surface of the lever side portion includes a recess that allows the retainer side portion to elastically deform outward. The stopper portion is disposed in the recess. The recess includes an excessive-rotation prevention portion (start-position overrun prevention portion and completion-position overrun prevention portion) that faces the stopper portion in the rotation direction of the lever and restricts excessive rotation of the lever.

### CROSS-REFERENCE TO RELATED APPLICATIONS

This application claims the benefit of Patent Application No. 2025-073016, filed in Japan on Apr. 25, 2025, the content of which is incorporated herein by reference.

### BACKGROUND OF THE INVENTION

### (1) Field of the Invention

The present disclosure relates to a lever-type connector.

### (2) Description of Related Art

JP 2024-60815 A discloses a lever-type connector including a housing, a lever rotatably supported with respect to the housing from a fitting start position to a fitting completion position, and a cover to be mounted on the housing. A rib is provided on an outer surface of the cover in a protruding manner. The rib includes a first receiving portion and a second receiving portion. The lever located at the fitting start position comes into contact with the first receiving portion, thereby restricting rotation of the lever in a direction opposite to the fitting completion position. Further, the lever located at the fitting completion position comes into contact with the second receiving portion, thereby restricting rotation of the lever in a direction opposite to the fitting start position.

### SUMMARY OF THE INVENTION

In JP 2024-60815 A, if the cover is omitted from the viewpoint of space saving, for example, the rib is also eliminated, and therefore excessive rotation of the lever cannot be restricted. On the other hand, by providing a rib on the housing and providing a recess in the lever for receiving the rib, and by configuring two end surfaces of the recess to serve as surfaces corresponding to the first receiving portion and the second receiving portion, respectively, it becomes possible to restrict excessive rotation of the lever while achieving space saving. However, if the above-described recess is provided as a dedicated portion for restricting excessive rotation of the lever, the structure of the lever becomes complicated due to the provision of the recess.

Therefore, an object of the present disclosure is to provide a lever-type connector that can restrict excessive rotation of a lever while achieving space saving and simplification of the structure.

A lever-type connector of the present disclosure is a lever-type connector including: a housing that accommodates a terminal; a lever rotatably supported with respect to the housing from a fitting start position to a fitting completion position; and a retainer movably mounted to the housing from a temporary locking position to a main locking position and capable of locking the terminal at the main locking position, in which the lever includes a lever side portion engageable with a mating connector, the housing includes a side surface covered by the lever side portion, the side surface is provided with a stop portion and a stopper portion protruding therefrom, the retainer includes a retainer side portion that elastically deforms to an outer side away from the side surface to ride over the stop portion and is locked to the stop portion at the main locking position, the lever side portion includes, on an inner surface facing the side surface, a recess that allows the retainer side portion to elastically deform to the outer side, the stopper portion is disposed in the recess, and the recess includes an excessive-rotation prevention portion that faces the stopper portion in a rotation direction of the lever and restricts excessive rotation of the lever.

According to the present disclosure, it is possible to provide a lever-type connector that can restrict excessive rotation of a lever while achieving space saving and simplification of the structure.

### BRIEF DESCRIPTION OF THE DRAWINGS

FIG. 1 is a side sectional view showing a state in which a housing is fitted to a mating connector in a lever-type connector of a first embodiment;

FIG. 2 is a rear view of the housing alone in the lever-type connector of the first embodiment;

FIG. 3 is a side view of the housing alone in the lever-type connector of the first embodiment;

FIG. 4 is a rear view of a retainer in the lever-type connector of the first embodiment;

FIG. 5 is a perspective view of a lever in the lever-type connector of the first embodiment;

FIG. 6 is an exploded side view showing a state immediately before the lever is assembled to the housing from above in the lever-type connector of the first embodiment;

FIG. 7 is a side view showing a state in which the lever is assembled to the housing in the lever-type connector of the first embodiment;

FIG. 8 is a partially enlarged side sectional view showing a state in which, when the lever is at an assembly position and fitting completion position with respect to the housing, a stopper portion disposed in a recess faces a completion-position overrun prevention portion, in the lever-type connector of the first embodiment;

FIG. 9 is a partially enlarged longitudinal sectional view showing a state in which, when the lever is at the assembly position and the fitting completion position with respect to the housing, a retainer side portion faces a bottom surface of the recess of a lever side portion, in the lever-type connector of the first embodiment;

FIG. 10 is a side view showing a state in which the lever is at a fitting start position with respect to the housing in the lever-type connector of the first embodiment;

FIG. 11 is a partially enlarged side sectional view showing a state in which, when the lever is at the fitting start position with respect to the housing, the stopper portion disposed in the recess faces a start-position overrun prevention portion, in the lever-type connector of the first embodiment; and

FIG. 12 is a partially enlarged longitudinal sectional view showing a state in which, when the lever is at the fitting start position, an opening-restriction surface of the stopper portion faces the start-position overrun prevention portion from a left-right outer side, in the lever-type connector of the first embodiment.

### DETAILED DESCRIPTION OF PREFERRED EMBODIMENTS

### Description of Embodiments of Present Disclosure

First, aspects of the present disclosure will be described in a listed manner.

A lever-type connector of the present disclosure (1) includes: a housing that accommodates a terminal; a lever rotatably supported with respect to the housing from a fitting start position to a fitting completion position; and a retainer movably mounted to the housing from a temporary locking position to a main locking position and capable of locking the terminal at the main locking position, in which the lever includes a lever side portion engageable with a mating connector, the housing includes a side surface covered by the lever side portion, the side surface is provided with a stop portion and a stopper portion protruding therefrom, the retainer includes a retainer side portion that elastically deforms to an outer side away from the side surface to ride over the stop portion and is locked to the stop portion at the main locking position, the lever side portion includes, on an inner surface facing the side surface, a recess that allows the retainer side portion to elastically deform to the outer side, the stopper portion is disposed in the recess, and the recess includes an excessive-rotation prevention portion that faces the stopper portion in a rotation direction of the lever and restricts excessive rotation of the lever.

In the process in which the retainer moves from the temporary locking position to the main locking position, the retainer side portion rides onto the stop portion and elastically deforms outward. Here, the recess functions as a space that allows the outward elastic deformation of the retainer side portion.

Further, excessive rotation of the lever is prevented by the excessive-rotation prevention portion facing the stopper portion. Here, the recess functions as a space for disposing the stopper portion and as a portion in which the excessive-rotation prevention portion is provided.

Since the recess has both a function as a space that allows elastic deformation of the retainer side portion and a function as a space for disposing the stopper portion, the structure of the lever can be simplified as compared with a case where these are provided in separate parts. Further, the recess is not provided in the cover. Therefore, for example, by omitting the cover from the lever-type connector, a space in which the cover could otherwise be provided can be effectively utilized, and as a result, space saving can be achieved.

(2) In the lever-type connector according to (1) described above, it is preferable that the recess includes two end portions spaced apart from each other in both directions of the rotation direction, the two end portions respectively include a start-position overrun prevention portion and a completion-position overrun prevention portion that face the stopper portion in the rotation direction and restrict a rotation range of the lever, and the excessive-rotation prevention portion is constituted by the start-position overrun prevention portion and the completion-position overrun prevention portion.

According to the configuration of (2) described above, the start-position overrun prevention portion can prevent the lever from rotating beyond the fitting start position, and the completion-position overrun prevention portion can prevent the lever from rotating beyond the fitting completion position.

(3) In the lever-type connector according to (1) or (2) described above, it is preferable that a protrusion amount of the stopper portion is greater than a protrusion amount of the stop portion.

Since the depth of the recess is formed in accordance with the stopper portion having a greater protrusion amount, a sufficient amount of outward elastic deformation of the retainer side portion can be ensured.

(4) In the lever-type connector according to any of (1) to (3) described above, it is preferable that a protruding end surface of the stopper portion faces a bottom surface in a depth direction of the recess in close proximity thereto.

When the lever side portion attempts to deform inward closer to the side surface of the housing, the protruding end surface of the stopper portion can come into contact with the bottom surface of the recess, thereby preventing the lever side portion from further deforming inward.

(5) In the lever-type connector according to any of (1) to (4) described above, it is preferable that the stopper portion includes an opening-restriction surface that faces the excessive-rotation prevention portion from the outer side of the excessive-rotation prevention portion.

The opening-restriction surface faces the excessive-rotation prevention portion from the outer side, thereby preventing the lever side portion from deforming to the outer side.

(6) In the lever-type connector according to any of (1) to (5) described above, it is preferable that the side surface is provided with a rotation shaft protruding therefrom at a position opposite to the stop portion with the stopper portion interposed therebetween, the lever side portion is provided with a bearing portion that is located at a rotation center portion of the lever to receive the rotation shaft, the lever is assembled to the housing by sliding in a direction intersecting a protruding direction of the rotation shaft, and the recess is located forward of the bearing portion in an assembly direction of the lever and is recessed in the protruding direction.

The recess can also have a function of avoiding excessive interference between the rotation shaft and the lever side portion in the assembly process of the lever.

(7) In the lever-type connector according to (6) described above, it is preferable that the recess includes a guide slope at a position facing the rotation shaft in the assembly direction, the guide slope being inclined forward in the assembly direction toward a bottom surface in a depth direction of the recess.

The lever side portion can smoothly ride onto the rotation shaft along the guide slope in the assembly process of the lever. In particular, since the guide slope is provided in the recess, complication of the structure of the lever side portion can be avoided.

(8) In the lever-type connector according to (7) described above, it is preferable that the stopper portion includes a retreat slope on a surface facing the rotation shaft in the assembly direction, the retreat slope being inclined in a direction away from the rotation shaft and facing the guide slope.

After the assembly of the lever with respect to the housing, the retreat slope faces the guide slope, thereby forming a state in which the stopper portion is disposed in the recess.

(9) In the lever-type connector according to any of (1) to (8) described above, it is preferable that the side surface is provided with a rotation shaft protruding therefrom at a position opposite to the stop portion with the stopper portion interposed therebetween, the lever side portion is provided with a bearing portion that is located at a rotation center portion of the lever to receive the rotation shaft, and in a case where the mating connector is to be fitted to the housing from a front side of the housing, the stopper portion includes a portion located forward of the rotation shaft in a front-rear direction and does not include a portion located rearward of the rotation shaft.

Since the stopper portion is not present rearward of the rotation shaft, a portion of the side surface of the housing located rearward of the rotation shaft does not need to be elongated in the front-rear direction.

### Details of Embodiments of Present Disclosure

A specific example of the present disclosure will be described below with reference to the drawings. Note that the present invention is not limited to this example, but is indicated by the claims, and is intended to include all modifications within the meaning and scope equivalent to the claims.

### First Embodiment

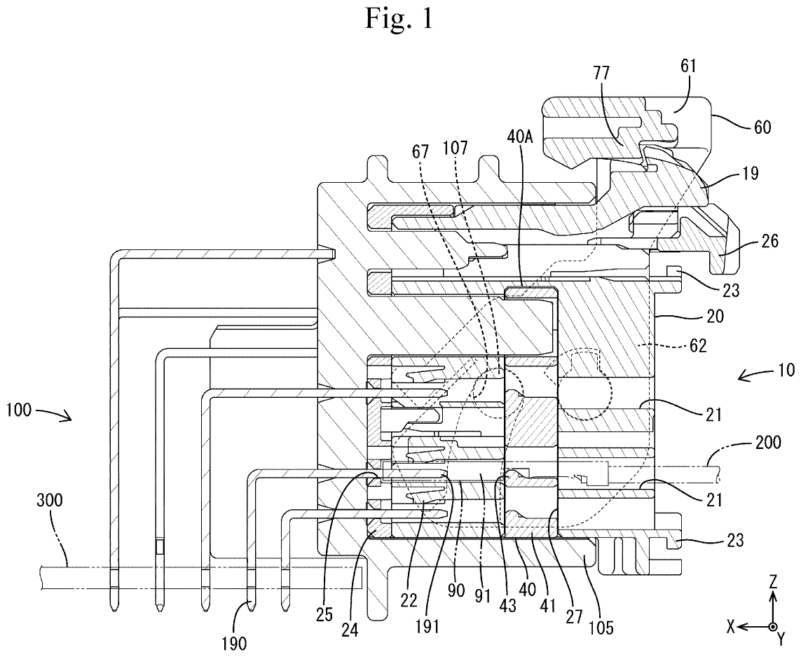

As shown in FIG. 1, a lever-type connector 10 of the first embodiment of the present disclosure includes a housing 20, a retainer 40, and a lever 60. The housing 20 accommodates a terminal 90. The housing 20 is fitted to a mating connector 100. The lever 60 is a member that assists fitting between the housing 20 and the mating connector 100. The retainer 40 is a member that prevents withdrawal of the terminal 90 from being withdrawn from the housing 20. In the following description, regarding the front-rear direction, the fitting direction of the housing 20 with respect to the mating connector 100 is defined as the front side. The up-down direction is based on the up-down direction in FIG. 1. The left-right direction is a direction orthogonal to both the front-rear direction and the up-down direction. Reference signs X, Y, and Z in FIG. 1 represent a front side, a right side, and an upper side, respectively. In the following description, unless otherwise specified, an inner side means a direction facing the center of the housing 20, and an outer side means a direction away from the center of the housing 20. The outer side in the left-right direction may be referred to as a left-right outer side. The reference of these directions is for convenience and does not necessarily coincide with the reference of the direction in a state where the lever-type connector 10 is mounted on a vehicle or the like not shown.

### Housing and the Like

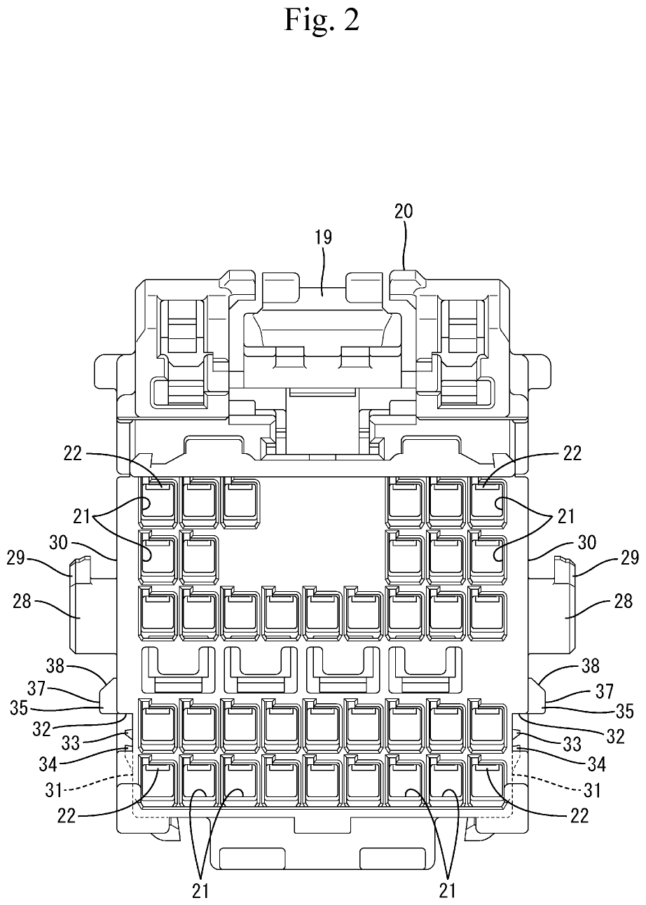

The housing 20 is made of synthetic resin. As shown in FIGS. 1 and 2, the housing 20 includes a plurality of cavities 21 that accommodate the terminals 90. In the housing 20, the cavities 21 are provided in a plurality of stages in the up-down direction and in a plurality of rows in the left-right direction. Each of the cavities 21 is provided with a lance 22 protruding from an inner surface thereof. The terminal 90 is locked to the lance 22.

The terminal 90 is a conductive metal plate material, and is connected to an end portion of an electric wire 200 as shown in FIG. 1. Here, the terminal 90 is configured as a female terminal and includes a box portion 91 that receives a tab 191 of a mating terminal 190. The tab 191 is soldered and connected to a circuit board 300 at a lower end portion thereof opposite to a portion connected to the box portion 91. The electric wire 200 is drawn out from the rear surface of the housing 20. Unlike the present first embodiment, a cover not shown may be mounted to the housing 20. The cover covers the rear surface of the housing 20 and leads out a plurality of the electric wires 200 in a predetermined direction. A rear end portion of the housing 20 is provided with an attachment portion 23 for mounting the cover.

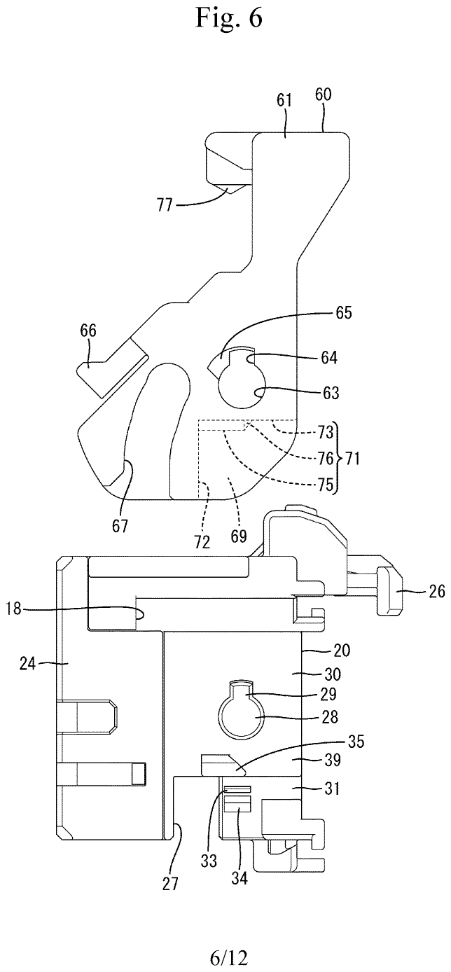

As shown in FIG. 6, a front mask 24 is mounted to the housing 20 from the front side. The front mask 24 is made of synthetic resin, and includes a tab insertion hole 25 through which the tab 191 can be inserted as shown in FIG. 1. An upper surface of the housing 20 is provided with a lock arm 19. The lock arm 19 locks a lock protrusion 77, which will be described later, of the lever 60 and holds the mating connector 100 and the housing 20 in a fitted state. A detection member 26 is mounted to the housing 20 from the rear side. The detection member 26 is made of synthetic resin and is engaged with the lock arm 19. The fitted state between the housing 20 and the mating connector 100 is detected based on whether or not the detection member 26 can move with respect to the housing 20.

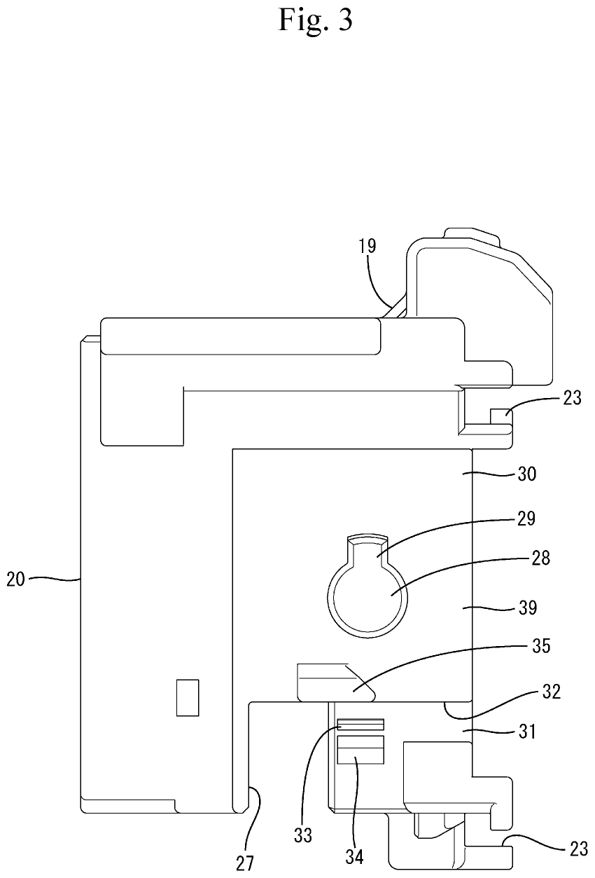

As shown in FIGS. 1 and 3, an intermediate portion of the housing 20 in the front-rear direction is provided with a retainer mounting hole 27. Each of the cavities 21 is divided into a front portion and a rear portion in the front-rear direction with the retainer mounting hole 27 therebetween. The retainer mounting hole 27 extends in the up-down direction and opens to the lower surface of the housing 20, and also opens from the lower surface of the housing 20 to side surfaces 30 (both side surfaces in the left-right direction). The retainer 40 is inserted into the retainer mounting hole 27 through the opening in the lower surface of the housing 20.

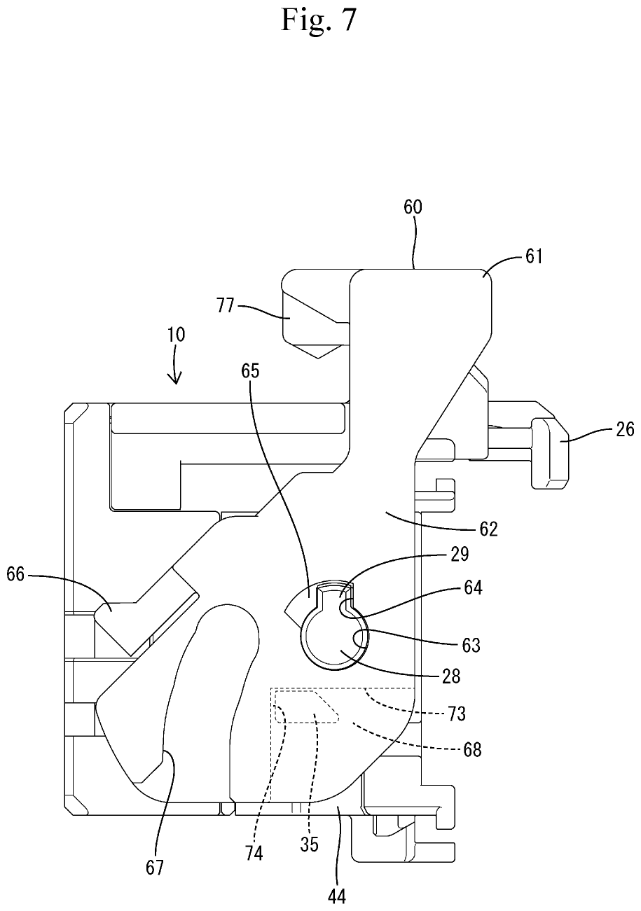

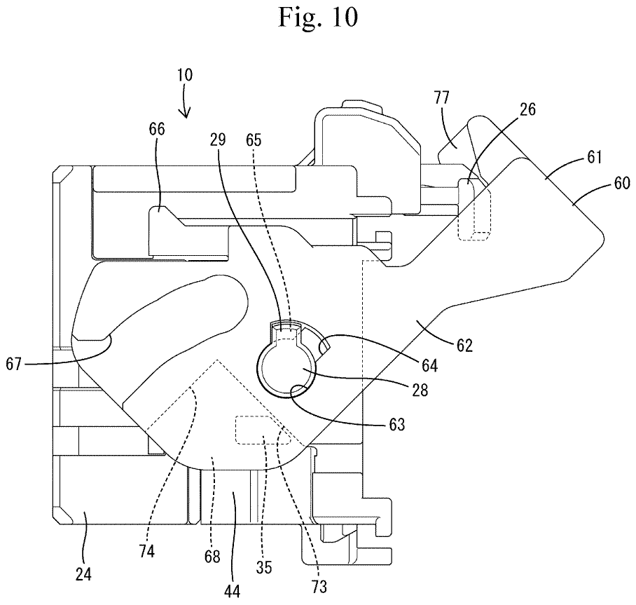

As shown in FIGS. 2 and 3, the side surface 30 of the housing 20 is provided with a rotation shaft 28 protruding therefrom. The rotation shaft 28 is disposed at the center in the up-down direction of the side surface 30 of the housing 20 and slightly rearward of the center in the front-rear direction. The rotation shaft 28 has a columnar shape and has a projection 29 projecting upward from a distal end portion on the left-right outer side. As shown in FIGS. 7 and 10, the rotation shaft 28 fits into a bearing portion 63 of the lever 60, which will be described later, and constitutes a rotation center portion of the lever 60 together with the bearing portion 63.

As shown in FIGS. 2 and 3, a lower portion of the side surface 30 of the housing 20 includes a recessed surface portion 31 recessed to the left-right inner side with respect to an upper portion 39 (a portion above a stepped surface 32 described later) of the side surface 30 including the rotation shaft 28. The retainer mounting hole 27 opens to the recessed surface portion 31. The side surface 30 of the housing 20 includes, between the upper portion 39 of the side surface 30 of the housing 20 and the recessed surface portion 31, the stepped surface 32 facing downward and extending in the front-rear direction in a side view.

The recessed surface portion 31 of the housing 20 is provided with a first stop portion 33 and a second stop portion 34 protruding therefrom. As shown in FIG. 3, the first stop portion 33 and the second stop portion 34 have a rib shape extending in the front-rear direction. The first stop portion 33 and the second stop portion 34 are in close proximity to the rear end of the retainer mounting hole 27 and are disposed side by side in the up-down direction. The first stop portion 33 is disposed above the second stop portion 34. The thickness of the second stop portion 34 in the up-down direction is greater than the thickness of the first stop portion 33 in the up-down direction. The first stop portion 33 and the second stop portion 34 have a function of retaining the retainer 40 at the temporary locking position and the main locking position described later.

The upper portion 39 of the side surface 30 of the housing 20 is provided with a stopper portion 35 protruding therefrom. The stopper portion 35 has a rib shape extending in the front-rear direction. The stopper portion 35 is disposed between the rotation shaft 28 and the first stop portion 33 in the up-down direction. The stopper portion 35 has a function of restricting the rotation range of the lever 60 (a function of defining the rotation range of the lever 60) together with a start-position overrun prevention portion 73 and a completion-position overrun prevention portion 74, which will be described later, of the lever 60.

As shown in FIG. 3, the front surface of the stopper portion 35 is located forward of the front end of each of the rotation shaft 28 and the first stop portion 33. The rear surface of the stopper portion 35 is located forward of the rear end of each of the rotation shaft 28 and the first stop portion 33. The stopper portion 35 includes a part overlapping with each of the rotation shaft 28 and the first stop portion 33 in the front-rear direction.

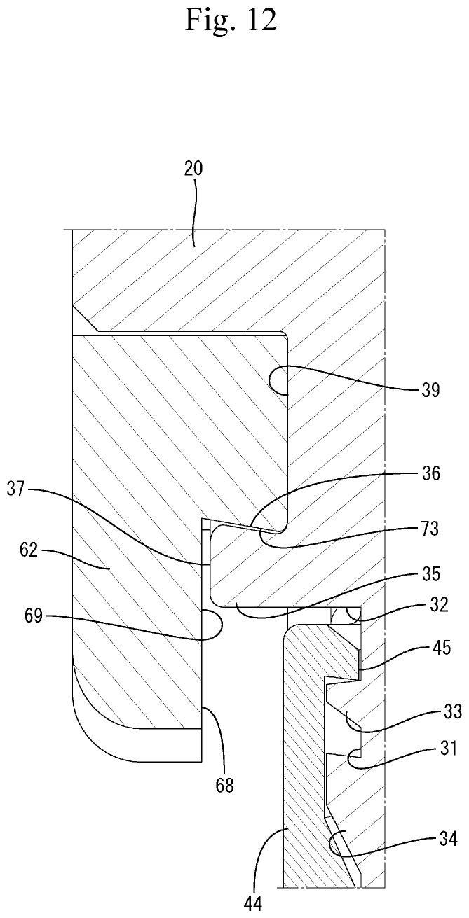

The front surface of the stopper portion 35 is disposed along the up-down direction and the left-right direction. The rear surface of the stopper portion 35 is inclined forward to the upper side in a side view and is disposed so as to face the rotation shaft 28 from below. As shown in FIG. 12, the rear surface of the stopper portion 35 constitutes an opening-restriction surface 36 having a reverse tapered shape that is inclined upward and rearward toward the left-right outer side in a cross-sectional shape taken in a direction intersecting the inclination direction. The opening-restriction surface 36 faces a lever side portion 62 of the lever 60, which will be described later, from the left-right outer side to restrict expansion of the lever side portion 62 toward the left-right outer side.

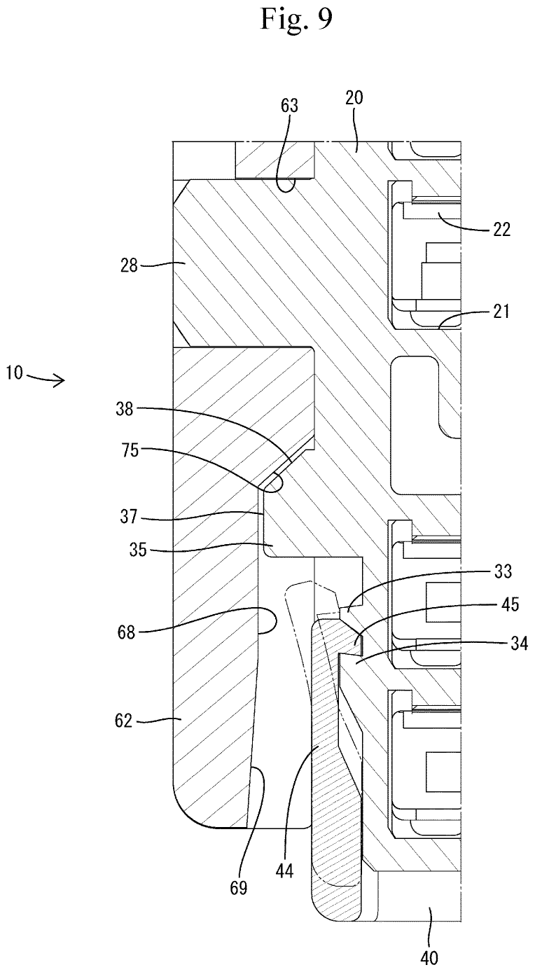

An end surface of the stopper portion 35 on the left-right outer side is a protruding end surfaces 37 extending along the front-rear direction and the up-down direction. A lower surface of the stopper portion 35 is disposed along the front-rear direction and the left-right direction, and as shown in FIG. 3, is continuous with the stepped surface 32 without a step. An upper surface of the stopper portion 35 is disposed along the front-rear direction, and as shown in FIG. 2, constitutes a retreat slope 38 inclined downward away from the rotation shaft 28 toward the protruding end surface 37. The retreat slope 38 is disposed so as to face the rotation shaft 28 from below. As shown in FIG. 9, the retreat slope 38 is formed so as to be able to avoid interference between a guide slope 75 of the lever 60, which will be described later, and the stopper portion 35. The protrusion amount of the stopper portion 35 from the upper portion 39 is greater than the protrusion amounts of the first stop portion 33 and the second stop portion 34 from the recessed surface portion 31, which are the same in the present first embodiment. The thickness of the stopper portion 35 in the up-down direction is greater than the thickness of the second stop portion 34 in the up-down direction.

### Retainer

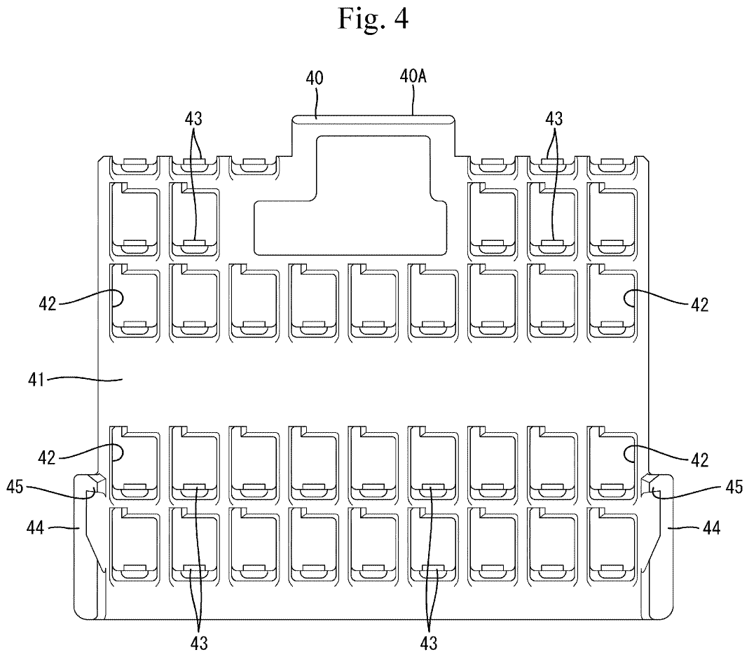

The retainer 40 is made of synthetic resin, and is movably mounted to the housing 20 between the temporary locking position (FIG. 9) and the main locking position (see FIGS. 1, 11, and 12). As shown in FIG. 4, the retainer 40 includes a retainer body portion 41 in a plate shape having a rectangular outer shape in a front view and having a thickness in the front-rear direction. The retainer body portion 41 is provided with a plurality of through holes 42. The through holes 42 are provided in a plurality of stages in the up-down direction and in a plurality of rows in the left-right direction so as to correspond to the cavities 21. The retainer 40 includes a plurality of retaining portions 43 on inner lower surfaces of the respective through holes 42 (surfaces facing upward) and at positions on the upper end surface of the retainer body portion 41 corresponding to the cavities 21 in the upper stage.

The retainer 40 includes a pair of left and right retainer side portions 44 on both end portions in the left-right direction with the retainer body portion 41 interposed therebetween. Each of the retainer side portions 44 has a plate shape and is disposed with a plate surface facing the left-right direction. Each of the retainer side portions 44 protrudes rearward from a portion connected to a lower portion of a corresponding one of the left and right side surfaces of the retainer body portion 41. The lower end surface of each of the retainer side portions 44 is disposed at a same height position as the lower surface of the retainer body portion 41. The upper end surface of each of the retainer side portions 44 is disposed at a height position below the center of the retainer body portion 41 in the up-down direction. Each of the retainer side portions 44 is elastically deformable in the left-right direction with a connection portion with the retainer body portion 41 as a fulcrum.

Each of the retainer side portions 44 described above includes a locking portion 45 on an inner surface thereof facing each other in the left-right direction. The locking portion 45 has a rib shape extending in the front-rear direction at the upper end portion of the inner surface of the retainer side portion 44. As shown in FIG. 9, the locking portion 45 is disposed, at the temporary locking position, so as to be sandwiched in the up-down direction between the first stop portion 33 and the second stop portion 34. The locking portion 45 comes into contact with the first stop portion 33 from below, whereby movement of the retainer 40 toward the main locking position at the temporary locking position is restricted. The locking portion 45 comes into contact with the second stop portion 34 from above, whereby downward detachment of the retainer 40 at the temporary locking position is restricted. Each of the retaining portions 43 retreats from an insertion path of the terminal 90 at the temporary locking position and allows passage of the box portion 91 toward a front portion of the cavity 21. At the temporary locking position, the lower end portion of the retainer 40 protrudes downward beyond the lower surface of the housing 20.

As shown in FIG. 12, at the main locking position, the locking portion 45 is disposed between the first stop portion 33 and the stepped surface 32. The locking portion 45 comes into contact with the first stop portion 33 from above, whereby movement of the retainer 40 toward the temporary locking position at the main locking position is restricted. An upwardly protruding portion 40A (see FIGS. 1 and 4) at the left and right central portion of the retainer body portion 41 comes into contact from below with an inner upper surface of the retainer mounting hole 27 (a surface facing downward), whereby upward movement of the retainer 40 at the main locking position is also restricted. At the main locking position, each of the retaining portions 43 is disposed so as to be lockable to the box portion 91 of the terminal 90. As shown in FIG. 1, at the main locking position, the lower surface of the retainer body portion 41 is disposed so as to be aligned with the lower surface of the housing 20 at the same height position.

### Lever

The lever 60 is made of synthetic resin, and is rotatably supported with respect to the housing 20 between the fitting start position (see FIGS. 10 to 12) and the fitting completion position (see FIGS. 1 and 7 to 9). The fitting completion position is also an assembly position at which the lever 60 is assembled to the housing 20. That is, the posture of the lever 60 with respect to the housing 20 is the same at the fitting completion position and the assembly position. In the following description of the structure of the lever 60, unless otherwise specified, the reference of the direction is based on the posture of the lever 60 at the fitting completion position and the assembly position as shown in FIG. 7.

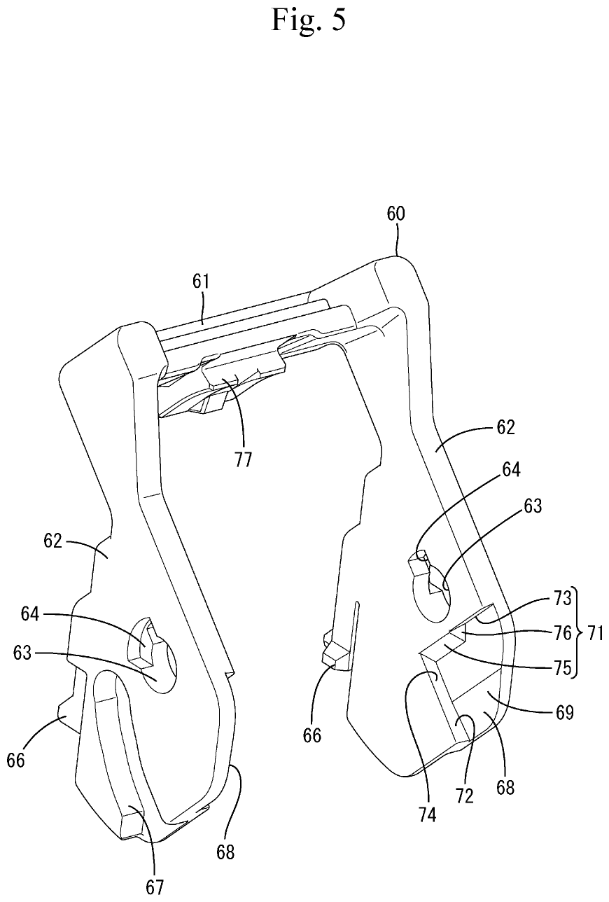

As shown in FIG. 5, the lever 60 has a gate shape as a whole, and includes an operation portion 61 extending in the left-right direction and a pair of left and right lever side portions 62 protruding from both ends of the operation portion 61 in the left-right direction while facing each other. The operation portion 61 has a strip plate shape, and is pinched and operated by a worker when the lever 60 is rotated. The center portion of the operation portion 61 in the left-right direction is provided with the lock protrusion 77. The lock protrusion 77 is disposed so as to be lockable to the lock arm 19 at the fitting completion position (see FIG. 1), and is disposed so as to be lockable to the detection member 26 at the fitting start position (see FIG. 10).

Each of the lever side portions 62 has a plate shape and is disposed with a plate surface facing the left-right direction. Each of the lever side portions 62 includes the bearing portion 63 penetrating in the left-right direction (plate thickness direction). As shown in FIG. 6, the bearing portion 63 includes a relief portion 64 having a rectangular shape extending upward from a portion having a circular shape in a side view. On the outer surface of the lever side portion 62 (the outer surface on the left-right outer side), an inner end surface 65 extending from the relief portion 64 along an opening edge of the bearing portion 63 is formed. The inner end surface 65 is disposed one step inward in the left-right direction from a surrounding surface on the outer surface of the lever side portion 62.

The lever 60 is assembled so as to straddle the housing 20 from above (see FIG. 6). In the assembly process of the lever 60, each of the lever side portions 62 interferes with the rotation shaft 28 and expands toward the left-right outer side with the connection portion with the operation portion 61 as a fulcrum. When the assembling of the lever 60 is completed, as shown in FIG. 7, each of the lever side portions 62 elastically returns, the rotation shaft 28 is fitted into the bearing portion 63, and the projection 29 is inserted into the relief portion 64. When the lever 60 is rotated, as shown in FIG. 10, the projection 29 faces the inner end surface 65 from the left-right outer side, thereby restricting expansion of the lever side portion 62 toward the left-right outer side.

The lever side portion 62 is provided with an elastic locking portion 66. The elastic locking portion 66 is elastically deformable in the left-right direction and is provided along the outer peripheral edge of the lever side portion 62. The elastic locking portion 66 is locked to a locking step portion 18 of the housing 20 (see FIG. 6), the lever 60 is held at the fitting start position in a state in which rotation toward the fitting completion position is restricted.

As shown in FIG. 5, each of the lever side portions 62 is provided with a cam groove 67. The cam groove 67 extends in a curved shape and opens to the outer peripheral edge of the lever side portion 62. Here, the cam groove 67 opens to the outer surface of the lever side portion 62 and is closed by the inner surface of the lever side portion 62. When the housing 20 is fitted to the mating connector 100, a cam pin 107 (see FIG. 1) of the mating connector 100 is inserted into the cam groove 67 from the left-right outer side. When the lever 60 is rotated, the cam pin 107 moves while making contact along the groove surface of the cam groove 67, whereby fitting and withdrawal of the mating connector 100 and the housing 20 proceed with a low fitting force. The cam pin 107 is provided on a hood portion 105 of the mating connector 100. As shown in FIG. 1, when the lever 60 is at the fitting completion position, the cam pin 107 reaches an inner end of the cam groove 67, and the housing 20 and the lever 60 are inserted into the hood portion 105 except for the respective rear end portions thereof.

As shown in FIG. 5, inner surfaces of the lever side portions 62 facing each other are each provided with a recess 68. The recess 68 is formed by reducing the thickness of the lever side portion 62 in the left-right direction at a portion on the inner surface of the lever side portion 62 below the bearing portion 63 and rearward of the cam groove 67. A bottom surface 69 of the recess 68 in the depth direction is disposed along the front-rear direction. An upper portion of the bottom surface 69 is disposed along the up-down direction. As shown in FIG. 9, a lower portion of the bottom surface 69 is disposed slightly inclined toward the left-right outer side as it extends downward. At the time of assembling the lever 60, a riding movement of the lever side portion 62 onto the rotation shaft 28 is guided by the inclined shape of the lower portion of the bottom surface 69. As shown in FIG. 9, the depth of the recess 68 is slightly greater than the protrusion dimension of the stopper portion 35. The stopper portion 35 is disposed in the recess 68. The depth of the recess 68 is set to be greater than the elastic deformation amount of the retainer side portion 44.

As shown in FIGS. 5, 8, and 11, the recess 68 is open downward and rearward of the lever side portion 62, and has an upper end defined by a first end portion 71 extending in the front-rear direction and a front end defined by a second end portion 72 extending in the up-down direction. The first end portion 71 and the second end portion 72 face each other with an angle difference of 90 degrees or approximately 90 degrees in the rotation direction of the lever 60, and are disposed at both ends in the rotation direction.

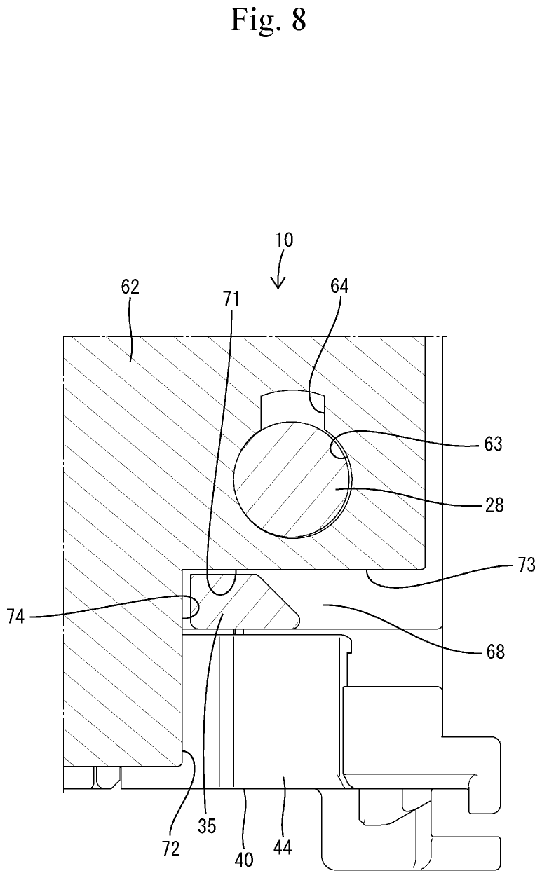

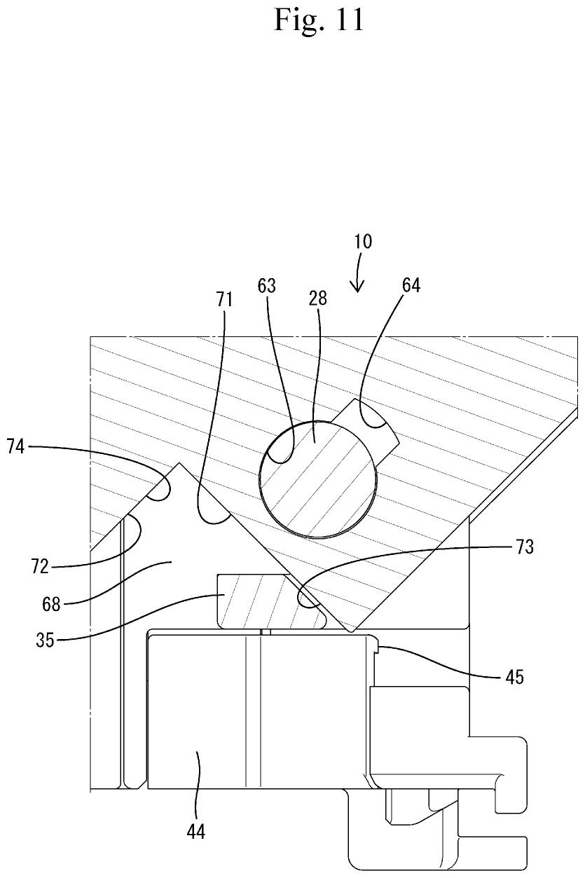

As shown in FIG. 11, the first end portion 71 includes the start-position overrun prevention portion 73 that faces the rear surface of the stopper portion 35 so as to be contactable therewith at the fitting start position. As shown in FIG. 8, the second end portion 72 includes the completion-position overrun prevention portion 74 that faces the front surface of the stopper portion 35 so as to be contactable therewith at the fitting completion position. In the present first embodiment, the start-position overrun prevention portion 73 and the completion-position overrun prevention portion 74 constitute the excessive-rotation prevention portion.

As shown in FIG. 5, the start-position overrun prevention portion 73 is provided at a rear portion of the first end portion 71. As shown in FIG. 12, the start-position overrun prevention portion 73 is an end surface facing downward, and has a reverse tapered shape inclined downward as it extends from the bottom surface 69 toward the left-right inner side so as to intersect the bottom surface 69 at an acute angle.

As shown in FIG. 5, a front portion of the first end portion 71 has a build-up shape protruding downward with respect to the start-position overrun prevention portion 73, and includes the guide slope 75 having a tapered shape inclined upward as it extends from the bottom surface 69 toward the left-right inner side so as to intersect the bottom surface 69 at an obtuse angle. Left-right inner ends of the guide slope 75 and the start-position overrun prevention portion 73 are continuously formed in a straight line along the front-rear direction. The guide slope 75 comes into contact with the rotation shaft 28 in the assembly process of the lever 60 and guides expansion of the lever side portion 62 toward the left-right outer side. A rear surface of the build-up shape at the front portion of the first end portion 71 is disposed at a center of the first end portion 71 in the front-rear direction, and forms an inclined surface 76 (see FIG. 6) inclined forward as it extends from the bottom surface 69 toward the left-right inner side.

The completion-position overrun prevention portion 74 is provided at an upper portion of the second end portion 72. The second end portion 72 is an end surface facing rearward as a whole including the completion-position overrun prevention portion 74, and is disposed along the left-right direction and the up-down direction. An upper end of the completion-position overrun prevention portion 74 intersects the front end of the first end portion 71 at a right angle.

### Operation of Lever-Type Connector

Next, an example of the operation of the lever-type connector 10 will be described. During assembly of the lever 60, when the lever 60 descends from the state of FIG. 6, the bottom surface 69 of the recess 68 of the lever side portion 62 moves along the side surface 30 of the housing 20, thereby avoiding interference between the lever side portion 62 and the housing 20 is avoided. Immediately before the lever 60 reaches the assembly position, the rotation shaft 28 comes into sliding contact with the guide slope 75, whereby the lever side portion 62 gradually elastically deforms (expands and deforms) toward the left-right outer side. When the lever 60 reaches the assembly position, the lever side portion 62 elastically returns, and the rotation shaft 28 fits into the bearing portion 63 in a light press-fit state (see FIG. 7). At the assembly position, the stopper portion 35 enters the recess 68 from the left-right inner side. The stopper portion 35 is disposed along the front portion of the first end portion 71 and the upper portion of the second end portion 72. Here, the guide slope 75 faces the retreat slope 38 so as to be contactable therewith, whereby interference between the lever side portion 62 and the stopper portion 35 is avoided (see FIG. 9). At the assembly position, the operation portion 61 is positioned above the rotation shaft 28 (see FIG. 7).

Before or after the assembly of the lever 60 described above, the retainer 40 is inserted into the retainer mounting hole 27 from below the housing 20. Then, the locking portion 45 rides onto the second stop portion 34, and the retainer side portion 44 is elastically deformed toward the left-right outer side. At this time, even if the lever 60 has already been assembled and the left-right outer side of the retainer side portion 44 is covered by the lever side portion 62, the elastically deformed retainer side portion 44 enters the recess 68, whereby interference between the retainer side portion 44 and the lever side portion 62 is avoided.

Thereafter, the retainer side portion 44 elastically returns, and the locking portion 45 comes into contact with the upper surface of the second stop portion 34 (see FIG. 9). As a result, the retainer 40 is held at the temporary locking position in a state in which detachment is restricted. When the retainer 40 is at the temporary locking position, the terminal 90 connected to the end portion of the electric wire 200 is inserted into the cavity 21 of the housing 20 from the rear side. The terminal 90 is locked by the lance 22, whereby withdrawal of the terminal 90 from the cavity 21 toward the rear side is temporarily restricted.

Next, the retainer 40 is pushed upward toward the main locking position. In the process in which the retainer 40 moves toward the main locking position, the locking portion 45 rides onto the first stop portion 33, and the retainer side portion 44 is elastically deform toward the left-right outer side (see the two-dot chain line in FIG. 9). As in the case of the time of assembly of the retainer 40 described above, even if the lever side portion 62 covers the retainer side portion 44 from the left-right outer side, the recess 68 allows elastic deformation of the retainer side portion 44 toward the left-right outer side, whereby interference between the retainer side portion 44 and the lever side portion 62 is avoided.

Meanwhile, in a state where the stopper portion 35 is disposed in the recess 68, as shown in FIG. 9, the protruding end surface 37 of the stopper portion 35 faces the bottom surface 69 of the recess 68 in close proximity thereto. Therefore, even if the lever side portion 62 attempts to elastically deform toward the left-right inner side, the bottom surface 69 of the recess 68 abuts against the protruding end surface 37 of the stopper portion 35, whereby further deformation of the lever side portion 62 is restricted. Accordingly, an opening dimension of the recess 68 in the left-right direction can be maintained constant, and reliability of avoiding interference between the retainer side portion 44 and the lever side portion 62 can be enhanced.

When the retainer 40 reaches the main locking position, the retainer side portion 44 elastically returns, and the locking portion 45 comes into contact with the upper surface of the first stop portion 33 (see FIG. 12). As a result, the retainer 40 is held at the main locking position in a state in which movement toward the temporary locking position is restricted. At the main locking position, the retaining portion 43 faces the box portion 91 of the terminal 90 from the rear side, whereby withdrawal of the terminal 90 from the cavity 21 toward the rear side is secondarily restricted (see FIG. 1).

Subsequently, the lever 60 is rotated about the rotation shaft 28 toward the fitting start position. As shown in FIG. 10, at the fitting start position, the operation portion 61 is disposed rearward of the rear surface of the housing 20. Further, at the fitting start position, as shown in FIG. 11, the rear surface of the stopper portion 35 (opening-restriction surface 36) is disposed to face the start-position overrun prevention portion 73 at the rear portion of the first end portion 71 from obliquely below so as to be contactable therewith. Here, the rear surface of the stopper portion 35 and the start-position overrun prevention portion 73 face each other in the rotation direction of the lever 60 and are disposed so as to be contactable along a direction intersecting the rotation direction. In the first embodiment, as shown in FIG. 12, the rear surface of the stopper portion 35 constitutes the opening-restriction surface 36 facing the start-position overrun prevention portion 73 from the left-right outer side, and the start-position overrun prevention portion 73 is inclined in a reverse tapered shape and is contactable with the opening-restriction surface 36 in a face-to-face state. Therefore, even if a worker applies a large force to the lever 60 to perform the rotation operation, rotation of the lever 60 beyond the fitting start position can be prevented with high reliability.

Thereafter, the housing 20 is inserted into the hood portion 105 of the mating connector 100, and the lever 60 is rotated about the rotation shaft 28 toward the fitting completion position. When the lever 60 reaches the fitting completion position, the housing 20 is properly fitted to the mating connector 100, and the terminal 90 is electrically connected to the mating terminal 190. As shown in FIG. 8, at the fitting completion position, the front surface of the stopper portion 35 is disposed to face the completion-position overrun prevention portion 74 at the upper end portion of the second end portion 72 from the front side so as to be contactable therewith. The front surface of the stopper portion 35 and the completion-position overrun prevention portion 74 face each other in the rotation direction of the lever 60 and are disposed so as to be contactable along the direction intersecting the rotation direction. Accordingly, rotation of the lever 60 beyond the fitting completion position is avoided. Further, at the fitting completion position, as shown in FIGS. 1 and 7, the rear end of the lever side portion 62 is disposed along the rear surface of the housing 20 so that the lever side portion 62 does not protrude rearward from the rear surface of the housing 20. Therefore, it is possible to avoid an increase in size of the lever-type connector 10 in the front-rear direction in the fitted state.

As described above, the lever-type connector 10 of the present first embodiment includes: the housing 20 that accommodates the terminal 90; the lever 60 rotatably supported with respect to the housing 20 from the fitting start position to the fitting completion position; and the retainer 40 movably mounted to the housing 20 from the temporary locking position to the main locking position. The lever 60 includes the lever side portion 62 engageable with the mating connector 100. The housing 20 includes the side surface 30 covered by the lever side portion 62. The side surface 30 of the housing 20 is provided with the first stop portion 33 (stop portion) and the stopper portion 35 protruding therefrom. The retainer 40 includes the retainer side portion 44 that elastically deforms outward away from the side surface 30 to ride over the first stop portion 33 and is locked to the first stop portion 33 at the main locking position. The lever side portion 62 includes, on the inner surface facing the side surface 30, the recess 68 that allows the retainer side portion 44 to elastically deform outward. The stopper portion 35 is disposed in the recess 68. The recess 68 includes an excessive-rotation prevention portion (here, the start-position overrun prevention portion 73 and the completion-position overrun prevention portion 74) that faces the stopper portion 35 in the rotation direction of the lever 60 and restricts excessive rotation of the lever 60.

In the process in which the retainer 40 moves from the temporary locking position to the main locking position, the retainer side portion 44 rides onto the first stop portion 33 and elastically deforms outward. Here, the recess 68 functions as a space that allows the outward elastic deformation of the retainer side portion 44. Further, excessive rotation of the lever 60 beyond the rotation range is prevented by the start-position overrun prevention portion 73 and the completion-position overrun prevention portion 74 facing the stopper portion 35. Here, the recess 68 functions as a space for disposing the stopper portion 35 and as a portion in which the start-position overrun prevention portion 73 and the completion-position overrun prevention portion 74 are provided.

Since the recess 68 has both a function as a space that allows elastic deformation of the retainer side portion 44 and a function as a space for disposing the stopper portion 35, the structure of the lever 60 can be simplified as compared with a case where portions having there functions are provided separately. Further, for example, by omitting the cover from the lever-type connector 10, a space in which the cover could otherwise be provided can be effectively utilized, and as a result, space saving can be achieved.

Further, in the present first embodiment, the protrusion amount of the stopper portion 35 is greater than the protrusion amount of the first stop portion 33. Since the depth of the recess 68 is formed in accordance with the stopper portion 35 having a greater protrusion amount, a sufficient amount of outward elastic deformation of the retainer side portion 44 can be ensured. Moreover, the protruding end surface 37 of the stopper portion 35 faces the bottom surface 69 of the recess 68 in close proximity thereto. Accordingly, when the lever side portion 62 attempts to deform to the left-right inner side closer to the side surface 30 of the housing 20, the protruding end surface 37 of the stopper portion 35 can come into contact with the bottom surface 69 of the recess 68, thereby preventing deformation of the lever side portion 62 toward the left-right inner side.

Further, since the stopper portion 35 includes the opening-restriction surface 36 that faces the start-position overrun prevention portion 73 from the left-right outer side of the start-position overrun prevention portion 73, it is also possible to prevent the lever side portion 62 from deforming to the left-right outer side.

Further, the side surface 30 of the housing 20 is provided with the rotation shaft 28 protruding therefrom at a position opposite to the first stop portion 33 with the stopper portion 35 interposed therebetween. The lever side portion 62 is provided with the bearing portion 63 that receives the rotation shaft 28. The lever 60 is assembled to the housing 20 by sliding in a direction (up-down direction) intersecting the protruding direction of the rotation shaft 28. The recess 68 is located forward of (below) the bearing portion 63 in the assembly direction of the lever 60 and is recessed in the protruding direction (left-right outer side) of the rotation shaft 28. Therefore, the recess 68 can also have a function of avoiding excessive interference between the rotation shaft 28 and the lever side portion 62 in the assembly process of the lever 60.

Further, the recess 68 includes the guide slope 75 at a position facing the rotation shaft 28 in the assembly direction of the lever 60, the guide slope 75 being inclined forward (downward) in the assembly direction toward the bottom surface 69 of the recess 68. According to this configuration, the lever side portion 62 can smoothly ride onto the rotation shaft 28 along the guide slope 75 in the assembly process of the lever 60. In particular, since the guide slope 75 is provided in the recess 68, complication of the structure of the lever side portion 62 can be avoided. Further, the stopper portion 35 includes the retreat slope 38 on the surface facing the rotation shaft 28 in the assembly direction, the retreat slope 38 being inclined in the direction away from the rotation shaft 28 and facing the guide slope 75. According to this configuration, when the lever 60 is at the fitting completion position, the retreat slope 38 faces the guide slope 75, and a state in which and the stopper portion 35 is disposed along the first end portion 71 can be favorably formed.

Furthe, the stopper portion 35 includes a portion located forward of the rotation shaft 28 in the front-rear direction and does not include a portion located rearward of the rotation shaft 28. Since the stopper portion 35 is not present rearward of the rotation shaft 28, a portion of the side surface 30 of the housing 20 located rearward of the rotation shaft 28 does not need to be elongated in the front-rear direction, thereby avoiding an increase in size of the lever-type connector 10 in the front-rear direction as a whole.

### Another Embodiment of Present Disclosure

It should be considered that the first embodiment disclosed herein is illustrative in all respects and not restrictive.

In the above-described first embodiment, a cover is not attached to the housing. In contrast, according to another embodiment, a cover may be attached to the housing.

In the case of the first embodiment, the recess is a bottomed recess having a bottom surface in the depth direction. In contrast, according to another embodiment, the recess may be a bottomless recess having no bottom surface (a recess having no plate portion on a bottom side thereof).

In the above-described first embodiment, the first end portion including the start-position overrun prevention portion extends in the front-rear direction, and the second end portion including the completion-position overrun prevention portion extends in the up-down direction. In contrast, according to another embodiment, the first end portion and the second end portion may be set in accordance with the rotation direction, the rotation angle, and the like of the lever. For example, unlike the above-described first embodiment, the first end may extend in the up-down direction and the second end may extend in the left-right direction.

In the above-described first embodiment, the side surface of the housing is provided with the first stop portion and the second stop portion. In contrast, according to another embodiment, the side surface of the housing may be provided with only one stop portion (corresponding to the first stop portion of the above-described first embodiment). In this case, the retainer side portion of the retainer may preferably be provided with a temporary locking recess and a main locking recess configured to engage with the one stop portion at the temporary locking position and the main locking position, respectively.

In the above-described first embodiment, the linear distance from the rotation shaft to the stopper portion is shorter than the linear distance from the rotation shaft to the operation portion. In contrast, according to another embodiment, the linear distance from the rotation shaft to the stopper portion may be made longer than the linear distance from the rotation shaft to the operation portion in order to increase a strength for restricting excessive rotation of the lever.

In the above-described first embodiment, the opening-restriction surface of the stopper portion has a reverse tapered shape so as to face the start-position overrun prevention portion from the left-right outer side. In contrast, according to another embodiment, the opening-restriction surface of the stopper portion may have a concave or convex shape in the rotation direction so as to be engaged in a concave-convex manner with the start-position overrun prevention portion that has a convex or concave shape in the rotation direction while facing the start-position overrun prevention portion from the left-right outer side.

In the above-described first embodiment, the recess includes the start-position overrun prevention portion and the completion-position overrun prevention portion as the excessive-rotation prevention portion. In contrast, according to another embodiment, the recess may include only one of the start-position overrun prevention portion and the completion-position overrun prevention portion as the excessive-rotation prevention portion.

In the above-described first embodiment, the opening-restriction surface is provided so as to face the start-position overrun prevention portion from the outer side. In contrast, according to another embodiment, the opening-restriction surface may be provided so as to face the completion-position overrun prevention portion from the outer side. Further, the opening-restriction surface may be provided so as to face each of the start-position overrun prevention portion and the completion-position overrun prevention portion from the outer side.

1. A lever-type connector comprising:
a housing that accommodates a terminal;
a lever rotatably supported with respect to the housing from a fitting start position to a fitting completion position; and
a retainer movably mounted to the housing from a temporary locking position to a main locking position and capable of locking the terminal at the main locking position, wherein
the lever includes a lever side portion engageable with a mating connector,
the housing includes a side surface covered by the lever side portion,
the side surface is provided with a stop portion and a stopper portion protruding therefrom,
the retainer includes a retainer side portion that elastically deforms to an outer side away from the side surface to ride over the stop portion and is locked to the stop portion at the main locking position,
the lever side portion includes, on an inner surface facing the side surface, a recess that allows the retainer side portion to elastically deform to the outer side,
the stopper portion is disposed in the recess, and
the recess includes an excessive-rotation prevention portion that faces the stopper portion in a rotation direction of the lever and restricts excessive rotation of the lever.

2. The lever-type connector according to claim 1, wherein
the recess includes two end portions spaced apart from each other in both directions of the rotation direction,
the two end portions respectively include a start-position overrun prevention portion and a completion-position overrun prevention portion that face the stopper portion in the rotation direction and restrict a rotation range of the lever, and
the excessive-rotation prevention portion is constituted by the start-position overrun prevention portion and the completion-position overrun prevention portion.

3. The lever-type connector according to claim 1, wherein a protrusion amount of the stopper portion is greater than a protrusion amount of the stop portion.

4. The lever-type connector according to claim 3, wherein a protruding end surface of the stopper portion faces a bottom surface in a depth direction of the recess in close proximity thereto.

5. The lever-type connector according to claim 1, wherein the stopper portion includes an opening-restriction surface that faces the excessive-rotation prevention portion from the outer side of the excessive-rotation prevention portion.

6. The lever-type connector according to claim 1, wherein
the side surface is provided with a rotation shaft protruding therefrom at a position opposite to the stop portion with the stopper portion interposed therebetween,
the lever side portion is provided with a bearing portion that is located at a rotation center portion of the lever to receive the rotation shaft,
the lever is assembled to the housing by sliding in a direction intersecting a protruding direction of the rotation shaft, and
the recess is located forward of the bearing portion in an assembly direction of the lever and is recessed in the protruding direction.

7. The lever-type connector according to claim 6, wherein the recess includes a guide slope at a position facing the rotation shaft in the assembly direction, the guide slope being inclined forward in the assembly direction toward a bottom surface in a depth direction of the recess.

8. The lever-type connector according to claim 7, wherein the stopper portion includes a retreat slope on a surface facing the rotation shaft in the assembly direction, the retreat slope being inclined in a direction away from the rotation shaft and facing the guide slope.

9. The lever-type connector according to claim 1, wherein
the side surface is provided with a rotation shaft protruding therefrom at a position opposite to the stop portion with the stopper portion interposed therebetween,
the lever side portion is provided with a bearing portion that is located at a rotation center portion of the lever to receive the rotation shaft, and
in a case where the mating connector is to be fitted to the housing from a front side of the housing, the stopper portion includes a portion located forward of the rotation shaft in a front-rear direction and does not include a portion located rearward of the rotation shaft.
